(19) United States
(12) Patent Application Publication
(10) Pub. No.: US 2011/0029306 A1
(43) Pub. Date: Feb. 3, 2011

(54) AUDIO SIGNAL DISCRIMINATING DEVICE AND METHOD

(75) Inventors: Manho PARK, Daejeon (KR); Sook Jin Lee, Daejeon (KR); Jee Hwan Ahn, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/820,409

(22) Filed: Jun. 22, 2010

(30) Foreign Application Priority Data
Jul. 28, 2009 (KR) 10-2009-0068945

(51) Int. Cl. G10L 15/02

(52) U.S. Cl. 704/231; 704/E15.004

(57) ABSTRACT

An audio discriminating device includes a plurality of audio discriminators for discriminating an input audio signal as a speech signal or a non-speech signal by using at least one feature parameter, and determines whether to drive the audio discriminator connected next to the corresponding audio discriminator according to the audio discriminator's audio signal discriminating result.

### CROSS-REFERENCE TO RELATED APPLICATION

This application claims priority to and the benefit of Korean Patent Application No. 10-2009-0068945 filed in the Korean Intellectual Property Office on Jul. 28, 2009, the entire contents of which are incorporated herein by reference.

### BACKGROUND OF THE INVENTION

(a) Field of the Invention

The present invention relates to an audio discriminating device and method.

(b) Description of the Related Art

As communication techniques have been rapidly developed, communication bandwidths available for individuals have been steeply increased, and communication services used by users have widened the coverage from the short message service or the speech communication service to the multimedia communication service such as transmission of songs and video communication. Further, half of the data that are transmitted through the Internet are statistically classified as multimedia contents, and particularly, the appearance of personalized video contents such as user created contents (UCC) reinforces this trend. In addition, the application range of image transmission through the Internet has been extended from general image transmission to business purposes such as video conference, and recently, attempts to aggressively apply powerful visual effects through image communication to jobs of various fields have been activated.

Further, in order to efficiently use multimedia contents including audio and video in business work, audio information and image information can be efficiently searched and corresponding information must be provided, and it is also required to arrange audio information and image information with indexes. Conventionally, additional information such as text-based titles and descriptions input by the user is generally used in order to search audio information and image information. Particularly, a search service based on specific pattern recognition is provided to speech, and a search service based on face recognition, specific motion recognition, and specific object recognition using a video recognition scheme is provided to images.

Since the audio data closely relate to image data, it is also possible to use the audio data so as to search images. In this case, it is possible to check the flow of images as well as the entire image contents by using the audio data, and it is also possible to extract a keyword for the image by using the audio data.

However, it is required to separate in advance the speech part and the sound part so as to search images using audio because of the characteristic in which the general audio have the speech part and the additional sound part mixed. This is because when the image information is made to be an index by using the audio, the speech functions as an input having very important information, but the sound functions as an element for interrupting speech recognition.

General audio discrimination algorithms are classified as a simple method for comparing an extracted feature and a complex method for comparing multiple extracted features. The simple comparison method has less computation and generates less discrimination time, but generates many errors and thus has low reliability. The complex comparison method has high reliability, but has substantial computation on preprocessing, high complexity, and long processing time.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an audio discriminating device and method with increased reliability and reduced calculation.

An exemplary embodiment of the present invention provides an audio discriminating device including: a plurality of sequentially connected audio discriminators for discriminating an input audio signal as a speech signal or a non-speech signal; and a controller for determining whether to drive a second audio discriminator connected next to a first audio discriminator from among the plurality of audio discriminators based on the discriminating result of the first audio discriminator from among the plurality of audio discriminators, and finally discriminating the audio signal as a speech signal or a non-speech signal based on the result of discriminating the audio signal from among the plurality of audio discriminators.

Another embodiment of the present invention provides an audio discriminating method by an audio discriminating device, including: extracting at least one i-th feature parameter from an input audio signal; and performing the i-th discriminating for discriminating the audio signal as a speech signal or a non-speech signal by using the at least one i-th feature parameter, wherein the audio signal is discriminated as a non-speech signal at the i-th discrimination, or the extracting by increasing the i from 1 until the i reaches n and performing the i-th discrimination are repeated, the n is a predetermined natural number, and when the audio signal is discriminated as a speech signal at the n-th discrimination, the audio signal is finally discriminated as a speech signal.

Yet another embodiment of the present invention provides an audio discriminating method of an audio discriminating device, including: discriminating the audio signal as a speech signal or a non-speech signal by using at least one first feature parameter extracted by an input audio signal, thereby performing a first discrimination; when the audio signal is discriminated as a speech signal in the first discrimination, discriminating the audio signal as a speech signal or a non-speech signal by using at least one second feature parameter extracted by the audio signal, thereby performing a second discrimination; and finally discriminating the audio signal as a speech signal or a non-speech signal based on at least one result of the first discrimination and the second discrimination.

### BRIEF DESCRIPTION OF THE DRAWINGS

FIG. 1 shows a block diagram of an audio discriminating device according to an exemplary embodiment of the present invention.

FIG. 2 shows a flowchart of an audio discriminating method according to an exemplary embodiment of the present invention.

FIG. 3 shows a flowchart of per-stage audio discriminating process according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

An audio discriminating device and method according to an exemplary embodiment of the present invention will be described with reference to accompanying drawings.

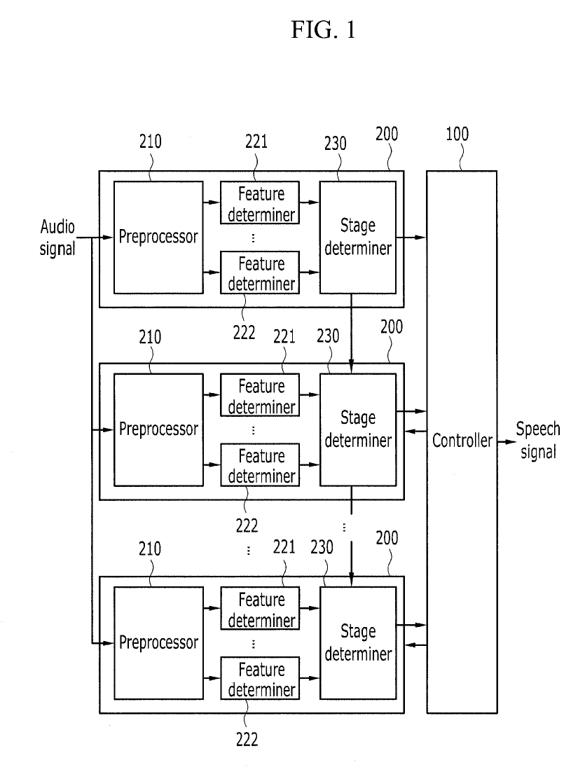

FIG. 1 shows a block diagram of an audio discriminating device according to an exemplary embodiment of the present invention.

Referring to FIG. 1, the audio discriminating device includes a controller 100 and a plurality of audio discriminators 200.

The controller 100 sequentially drives the plurality of audio discriminators 200 to perform an audio discriminating process for respective stages. Also, the controller 100 finally discriminates the audio signal based on the audio signal discriminating result by the audio discriminators 200, and outputs the audio signal that is discriminated to be a speech signal. Here, the audio signal that is discriminated to be a speech signal by the controller 100 can be used for speech recognition through a speech recognizing device (not shown). The controller 100 uses the audio discriminating result of the audio discriminator 200 connected before the corresponding audio discriminator 200 in order to determine the drive states of the respective audio discriminators 200. That is, when the audio discriminator 200 connected before the corresponding audio discriminator 200 has discriminated the audio signal to be a non-speech signal, the controller 100 does not drive the audio discriminator 200 any longer and terminates the audio discriminating process. Further, when the same audio discriminator 200 has discriminated the audio signal is a speech signal, the controller 100 drives the current audio discriminator 200 to perform an audio discriminating process. In this instance, non-speech signals represent signals except the speech signal from the audio signal, and include songs, sound effects, and noise.

The audio discriminators 200 are coupled in series, and respectively include a preprocessor 210, feature determiners 221 and 222, and a stage determiner 230.

The preprocessor 210 analyzes the input audio signal to extract at least one feature parameter. Here, the feature parameters extracted by the preprocessor 210 include spectral centroid, spectral flux, zero-crossing rate, roll-off point, frame energy, and pitch strength. The audio discriminators 200 discriminate the audio signal as a speech signal or a non-speech signal by using different feature parameters. Therefore, the feature parameters extracted by the preprocessor 210 are variable by the audio discriminators 200, and the number and types of the feature parameters extracted by the preprocessor 210 are selected in consideration of complexity and reliability when setting the audio discriminating device.

The feature determiners 221 and 222 generate determination values for the respective feature parameters extracted by the preprocessor 210. Here, the determination value generated for each feature parameter is generated by determining whether the corresponding feature parameter is near the speech signal or the non-speech signal. The number of the feature determiners 221 and 222 included by each audio discriminator 200 depends on the feature parameter extracted by the preprocessor 210 of the corresponding audio discriminator 200.

The stage determiner 230 multiplies a determination value per feature parameter (Value_{i-th feature determiner}) output by at least one of the feature determiners 221 and 222 by a weight value (Weight_{i-th feature determiner}) for indicating importance of each feature parameter, and sums the multiplied results as shown in Equation 1.

$${Value}_{n \text{-} th stage} = {\sum }_{i = 1}^{N} ( {Weight}_{i \text{-} th feature parameter} \times {Value}_{i \text{-} th feature parameter} \qquad ( Equation 1 )$$

Further, the stage determiner 230 generates a stage determination value (Output_{n-th stage}) as expressed in Equation 2 based on the summation value (Value_{n-th determiner}) generated through Equation 1.

$${Output}_{n \text{-} th stage} = \{ \begin{matrix}{Value}_{n \text{-} th stage} & if n = 1 \\ ( \begin{matrix}{Weight}_{( n - 1 ) \text{-} th stage} \times \\ {Output}_{( n - 1 ) \text{-} th stage}\end{matrix} ) + ( \begin{matrix}{Weight}_{n \text{-} th stage} \times \\ {Value}_{n \text{-} th stage}\end{matrix} ) , & if n > 1\end{matrix} \\ \qquad ( Equation 2 )$$

Referring to Equation 2, the stage determiner 230 of the first audio discriminator 200 selects the summation value (Value_{n-th determiner}) generated through Equation 1 as the stage determination value (Output_{n-th stage}). On the contrary, the stage determiner 230 of the second audio discriminator 200 uses the stage determination value (Output_{(n-1)-th stage}) of the audio discriminator 200 connected before the corresponding audio discriminator 200 as well as the summation value (Value_{n-th determiner}) generated through Equation 1 to generate the stage determination value (Output_{n-th stage}) of the current audio discriminator 200.

When the stage determination value (Output_{n-th stage}) is generated, the stage determiner 230 compares the same to the threshold value (Thresholdₙ₋ₜₕ stage) to discriminate the audio signal as shown in Equation 3.

$${Speech}_{n \text{-} th stage} = \{ \begin{matrix}True , & if {Output}_{n \text{-} th stage} \geq {Threshold}_{n \text{-} th stage} \\ False , & else\end{matrix} \qquad ( Equation 3 )$$

Referring to Equation 3, the stage determiner 230 discriminates the input audio signal is a speech signal when the stage determination value (Output_{n-th stage}) is greater than the threshold value (Threshold_{n-th stage}). However, when the stage determination value (Output_{n-th stage}) is less than the threshold value (Threshold_{n-th stage}), the stage determiner 230 discriminates the input audio signal is a non-speech signal. Here, different values are used for the threshold value (Threshold_{n-th stage}) for the respective stage determiners 230.

The discriminating result (Speech_{n-th stage}) that is determined through Equation 3 is output to the controller 100, and the controller 100 drives the next audio discriminator 200 or finally discriminates the audio signal based on the discriminating result.

For example, when the first audio discriminator 200 outputs the result (Speech_{first stage}) generated by discriminating the audio signal as a non-speech signal, the controller 100 turns off the audio discriminators 200 that are connected next to the first audio discriminator 200, and finally discriminates the audio signal as a non-speech signal. On the contrary, when the first audio discriminator 200 outputs the result (Speech_{first stage}) generated by discriminating the audio signal as a speech signal, the controller 100 turns on the second audio discriminator 200. Accordingly, the second audio discriminator 200 discriminates the audio signal.

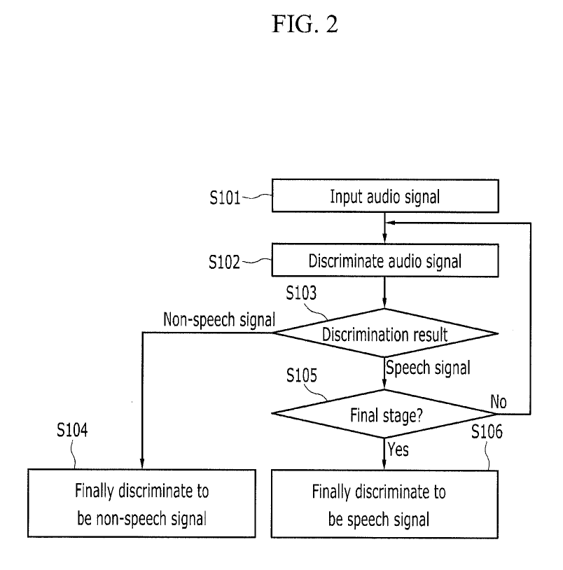

FIG. 2 shows a flowchart of an audio discriminating method by an audio discriminating device according to an exemplary embodiment of the present invention.

Referring to FIG. 2, the controller 100 of the audio discriminating device controls the first audio discriminator 200 to perform a first audio discriminating process (S102) when an audio signal is input (S101).

The controller 100 checks the first audio discriminating result (S103), and determines whether to proceed to the next process according to the discriminating result. That is, when the audio signal is discriminated as a non-speech signal, the controller 100 finally discriminates the input audio signal as a non-speech signal, and does not perform the audio discriminating process by turning off the audio discriminator 200 (S104). However, when the audio signal is discriminated as a speech signal, the controller 100 controls the second audio discriminator 200 to perform the next audio discriminating process (S102).

Accordingly, the processes S102 and S103 for performing the audio discriminating process for each stage and determining whether to perform the audio discriminating process of the next stage are repeated when the audio signal is discriminated as a non-speech signal, or until the last audio discriminator 200 performs the audio discriminating process of the final stage (S105).

When the audio signal is discriminated as a speech signal in the stages up to the final stage, the controller 100 finally discriminates the input audio signal as a speech signal (S106), and outputs the audio signal that is discriminated as a speech signal. In this instance, the controller 100 can provide the audio signal that is discriminated as a speech signal to a speech recognizing device (not shown), and the speech recognizing device generates speech information through speech recognition for the input speech signal. The generated speech information is used to configure index information of the image signal.

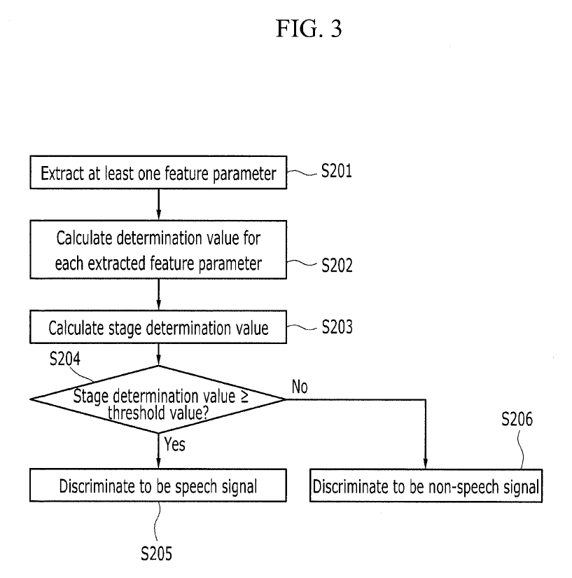

FIG. 3 shows a flowchart of per-stage audio discriminating process according to an exemplary embodiment of the present invention, illustrating a first audio discriminating process performed by a first audio discriminator.

Referring to FIG. 3, the audio discriminator 200 extracts at least one feature parameter through the preprocessor 210 (S201). The audio discriminator 200 generates a determination value for indicating nearness to a speech signal or a non-speech signal for each feature parameter extracted through at least one of the feature determiners 221 and 222 (S202).

The audio discriminator 200 applies a weight value to the determination value generated for each feature parameter through the stage determiner 230 and sums the applied results to generate a stage determination value (S203). Here, the first audio discriminating process uses the determination value that is generated for each feature parameter so as to generate the stage determination value. However, the second audio discriminating process uses the stage determination value that is generated from the audio discriminating process that is previously performed to generate the stage determination value in the current audio discriminating process. That is, a weight value is applied to the determination value for each feature parameter extracted in the audio discriminating process, the applied results are summed, a weight value is applied to the summed value and the stage determination value of the performed audio discriminating process, and the applied results are summed to generate the stage determination value in the audio discriminating process.

When the stage determination value is generated, the audio discriminator 200 compares the generated stage determination value and a threshold value (S204). When the stage determination value is greater than the threshold value, the input audio signal is discriminated as a speech signal (S205), and when the stage determination value is less than the threshold value, the input audio signal is discriminated as a non-speech signal (S206).

In the exemplary embodiment of the present invention, the audio discriminating process with multiple stages is sequentially performed to discriminate the audio signal and hence, reliability for the audio signal discriminating result is increased. Also, when the audio signal is discriminated as a non-speech signal through the audio discriminating process before the final stage, the audio discriminating process of the next stage is omitted to reduce complexity of the audio discriminating device and remove undesired performance of the audio discriminating process thereby decreasing computation and allowing real-time audio signal discrimination.

According to an embodiment of the present invention, reliability on the audio signal discrimination result is increased, and total computation is reduced and real-time audio signal determination is allowable by reducing complexity of the audio discriminating device and eliminating undesired performance of the audio discriminating process.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An audio discriminating device comprising:
a plurality of sequentially connected audio discriminators for discriminating an input audio signal as a speech signal or a non-speech signal; and
a controller for determining whether to drive a second audio discriminator connected next to a first audio discriminator from among the plurality of audio discriminators based on the discriminating result of the first audio discriminator from among the plurality of audio discriminators, and finally discriminating the audio signal as a speech signal or a non-speech signal based on the result of discriminating the audio signal from among the plurality of audio discriminators.

2. The audio discriminating device of claim 1, wherein
the first audio discriminator discriminates the audio signal as a non-speech signal, and the controller turns off the second audio discriminator and finally discriminates the audio signal as a non-speech signal.

3. The audio discriminating device of claim 1, wherein
when the first audio discriminator discriminates the audio signal as a speech signal, the controller turns on the second audio discriminator.

4. The audio discriminating device of claim 1, wherein
when the plurality of audio discriminators discriminate the audio signal as a speech signal, the controller finally discriminates the audio signal as a speech signal.

5. The audio discriminating device of claim 1, wherein
the audio discriminator extracts at least one corresponding feature parameter from the audio signal, and discriminates the audio signal as a speech signal or a non-speech signal by using the at least one feature parameter.

6. The audio discriminating device of claim 5, wherein
the plurality of audio discriminators have different extracted feature parameters.

7. The audio discriminating device of claim 5, wherein
the first audio discriminator from among the plurality of audio discriminator includes:
a preprocessor for extracting the at least one feature parameter from the audio signal;
at least one feature determiner for calculating a determination value for indicating whether the at least one feature parameter is near a speech signal or a non-speech signal for each feature parameter; and
a stage determiner for calculating a stage determination value from a determination value calculated for each at least one feature parameter, comparing the stage determination value and a threshold value, and discriminating the audio signal as a speech signal or a non-speech signal.

8. The audio discriminating device of claim 5, wherein
the audio discriminators except the first audio discriminator from among the plurality of audio discriminators respectively include:
a preprocessor for extracting the at least one feature parameter from the audio signal;
at least one feature determiner for calculating a determination value for indicating whether the at least one feature parameter is near a speech signal or a non-speech signal for each at least one feature parameter; and
a stage determiner for calculating a stage determination value, comparing the stage determination value and a threshold value, and discriminating the audio signal as a speech signal or a non-speech signal,
wherein the stage determiner calculates the stage determination value of the stage determiner from a determination value calculated by the at least one feature determiner and the stage determination value of an audio discriminator that is previously connected.

9. An audio discriminating method by an audio discriminating device, comprising:
extracting at least one i-th feature parameter from an input audio signal; and
performing i-th discriminating for discriminating the audio signal as a speech signal or a non-speech signal by using the at least one i-th feature parameter, wherein
the audio signal is discriminated as a non-speech signal at the i-th discrimination, or the extracting by increasing the i from 1 until the i reaches n and performing the i-th discrimination are repeated,
the n is a predetermined natural number, and
when the audio signal is discriminated as a speech signal at the n-th discrimination, the audio signal is finally discriminated as a speech signal.

10. The audio discriminating method of claim 9, wherein,
when the audio signal is discriminated as a non-speech signal at the i-th discrimination, the audio signal is finally discriminated as a non-speech signal.

11. The audio discriminating method of claim 9, wherein
the at least one i-th feature parameter is different from at least one (i−1)-th feature parameter.

12. The audio discriminating method of claim 9, wherein
the performing of the i-th discriminating includes:
calculating a determination value for indicating whether the at least one i-th feature parameter is near a speech signal or a non-speech signal for each at least one i-th feature parameter;
calculating the i-th stage determination value by using the determination value that is calculated for each at least one i-th feature parameter; and
discriminating the audio signal as a speech signal or a non-speech signal by comparing the i-th stage determination value and the i-th threshold value.

13. The audio discriminating method of claim 12, wherein
the calculating of the i-th stage determination value includes:
applying a weight value to the determination value that is calculated for each at least one i-th feature parameter; and
calculating the i-th stage determination value by summing the determination values to which the weight value is applied.

14. The audio discriminating method of claim 12, wherein
the calculating of the i-th stage determination value includes:
applying a first weight value to a determination value that is calculated for each at least one i-th feature parameter;
applying a second weight value to the summation of the determination values to which the first weight value is applied and the (i−1)-th stage determination value; and
calculating the stage determination value by summing the summation to which the second weight value is applied and the (i−1)-th stage determination value.

15. An audio discriminating method of an audio discriminating device, comprising:
discriminating the audio signal as a speech signal or a non-speech signal by using at least one first feature parameter extracted by an input audio signal, thereby performing a first discrimination;
when the audio signal is discriminated as a speech signal in the first discrimination, discriminating the audio signal as a speech signal or a non-speech signal by using at least one second feature parameter extracted by the audio signal, thereby performing a second discrimination; and
finally discriminating the audio signal as a speech signal or a non-speech signal based on at least one result of the first discrimination and the second discrimination.

16. The audio discriminating method of claim 15, wherein
the final discrimination includes
finally discriminating the audio signal as a non-speech signal when at least one of the first discrimination and the second discrimination discriminates the audio signal as a non-speech signal.

17. The audio discriminating method of claim 15, wherein
the performing of the first discrimination includes:
extracting the at least one first feature parameter from the audio signal;
calculating a determination value for indicating whether the at least one first feature parameter is near a speech signal or a non-speech signal for each at least one first feature parameter; and
discriminating the audio signal as a speech signal or a non-speech signal by using the determination value that is calculated for each at least one first feature parameter.

18. The audio discriminating method of claim 17, wherein
the discriminating of the audio signal includes:
applying a weight value to the determination value for each at least one first feature parameter;
calculating a first stage determination value by summing the determination values to which the weight value is applied; and
discriminating the audio signal as a speech signal when the first stage determination value is greater than the first threshold value.

19. The audio discriminating method of claim 18, wherein
the performing of the second audio discrimination includes:
extracting the at least one second feature parameter from the audio signal;
calculating a determination value for indicating whether the at least one second feature parameter is near a speech signal or a non-speech signal for each at least one second feature parameter;
applying a first weight value to the determination value that is calculated for each at least one second feature parameter;
calculating a summation value generated by summing the determination values to which the first weight value is applied;
applying a second weight value to the summation value and the first stage determination value;
calculating a second stage determination value that is generated by summing the summation value to which the second weight value is applied and the first stage determination value; and
discriminating the audio signal as a speech signal when the second stage determination value is greater than a second threshold value.
